(19) United States
(12) Patent Application Publication
(10) Pub. No.: US 2021/0331601 A1
(43) Pub. Date: Oct. 28, 2021

(54) DISPATCHING METHOD AND SYSTEM FOR ELECTRIC VEHICLE BATTERY SWAPPING STATION

(71) Applicant: YANSHAN UNIVERSITY, Qinhuangdao City (CN)

(72) Inventors: Jie YANG, Qinhuangdao City (CN); Anhu ZHU, Qinhuangdao City (CN); Kai MA, Qinhuangdao City (CN); Tieding MA, Qinhuangdao City (CN); Zehui LI, Qinhuangdao City (CN); Wenya XU, Qinhuangdao City (CN)

(21) Appl. No.: 17/150,780

(22) Filed: Jan. 15, 2021

(30) Foreign Application Priority Data
Apr. 23, 2020 (CN) 202010326244.4

(51) Int. Cl. B60L 53/80; B60L 58/12; B60L 58/16; B60S 5/06; G06Q 30/02; G06Q 10/06; G06Q 50/06

(52) U.S. Cl. CPC B60L 53/80; B60L 58/12; B60L 58/16; G06Q 50/06; G06Q 30/0283; G06Q 10/06315; B60S 5/06

(57) ABSTRACT

The present disclosure discloses a dispatching method and system for an electric vehicle battery swapping station. The dispatching method includes: acquiring battery data of electric vehicles and demand of battery swapping of users; determining total charging power and average charging power of a battery swapping station; determining a battery swapping price; determining an objective function of optimized dispatching of the electric vehicle battery swapping station according to the battery swapping price and the battery data; optimizing, according to a constraint condition and the objective function, a charging state of batteries in the battery swapping station and the demand of the battery swapping to obtain an optimized charging state of the batteries in the battery swapping station and optimized demand of the battery swapping; and performing the optimized dispatching on the electric vehicle battery swapping station.

### TECHNICAL FIELD

The present disclosure relates to the technical field of optimized dispatching, in particular to a dispatching method and system for an electric vehicle battery swapping station.

### BACKGROUND

Different from traditional vehicles, new energy electric vehicles as novel green transportation are powered by driving motors with electric energy. Thus, battery charging stations and battery swapping stations are regarded as “gas stations” of the new energy electric vehicles.

Power batteries of the electric vehicles have both advantages and disadvantages for the whole power system. Firstly, due to randomness of charging load and uncertainty of charging time of the electric vehicles, it poses greater challenges to the safe operation of the power system. Moreover, with popularization of the electric vehicles, large-scale charging loads of the electric vehicles are concentrated due to the lack of proper optimized control and coordination on the charging loads; and as a result, increased peak loads and larger peak-valley differences are generated in a power system. Consequentially, the safe and economic operation of the power system will be affected. Secondly, the power batteries serve as better standby resources for the power system by virtue of their energy storage to discharge to the power system during a peak and be charged during a valley, so as to realize peak shaving and valley filling. Moreover, the power batteries are of great significance to promote consumption of new energy.

As large-scale electric vehicles are charged disorderly, the power system will be greatly impacted. From this, stability and power quality of the power system will be seriously threatened. Thus, it is urgent to find a way to achieve optimized dispatching of the electric vehicles for stable operation of the power system.

### SUMMARY

The present disclosure aims to provide a dispatching method and system for an electric vehicle battery swapping station, which can achieve ordered battery charging and battery swapping of the electric vehicles, thus improving the effects of peak shaving and valley filling of a power system.

To achieve the above objective, the present disclosure provides the following solutions:

A dispatching method for an electric vehicle battery swapping station includes:

acquiring battery data of electric vehicles and demand of battery swapping of users, where the battery data includes charging power, state of charge (SOC), state of health (SOH), and rated capacity of batteries;

determining total charging power and average charging power of a battery swapping station according to the charging power of the batteries and the demand of the battery swapping of the users;

determining a battery swapping price according to the total charging power and average charging power of the battery swapping station;

determining an objective function of optimized dispatching of the electric vehicle battery swapping station according to the battery swapping price and the battery data;

optimizing, according to a constraint condition and the objective function, a charging state of batteries in the battery swapping station and the demand of the battery swapping to obtain an optimized charging state of the batteries in the battery swapping station and optimized demand of the battery swapping; where, the constraint condition includes constraints on the SOH of the batteries, the SOC of the batteries, the demand of the battery swapping, the number of rechargeable batteries, and the battery swapping price; and

performing the optimized dispatching on the electric vehicle battery swapping station according to the optimized charging state of the batteries in the battery swapping station and the optimized demand of the battery swapping.

Optionally, the step of determining total charging power and average charging power of a battery swapping station according to the charging power of the batteries and the demand of the battery swapping of the users particularly includes:

determining the total charging power of the battery swapping station according to the following formula:

$${P}_{BSS , i} = {\sum }_{i = 1}^{T} {P}_{i} \cdot {S}_{i} ;$$

and

determining the average charging power of the battery swapping station according to the following formula:

$${P}_{av} = \frac{1}{T} {\sum }_{i = 1}^{T} {P}_{i} \cdot {S}_{i} ;$$

where, P_{BSS,i} represents total charging power of the battery swapping station during time period i; Pₐᵥ represents the average charging power of the battery swapping station; Pᵢ represents charging power of the batteries during time period i; Sᵢ represents demand of the battery swapping of the users during time period i; and T represents total time.

Optionally, the step of determining a battery swapping price according to the total charging power and average charging power of the battery swapping station particularly includes:

determining the battery swapping price according to the following formula:

$${pri}_{i} = \{ \begin{matrix}⌊ \frac{{P}_{BSS , i} - {P}_{av}}{{step}_{p}} ⌋ \cdot {step}_{pri} + {pri}_{i - 1} & if {P}_{BSS , i} - {P}_{av} \geq {step}_{p} , {P}_{BSS , i}^{′} > 0 \\ {pri}_{i - 1} - ⌊ \frac{{P}_{BSS , i} - {P}_{av}}{{step}_{p}} ⌋ \cdot {step}_{pri} & if {P}_{BSS , i} - {P}_{av} \geq {step}_{p} , {P}_{BSS , i}^{′} < 0 \\ {pri}_{i - 1} & else\end{matrix} ;$$

where, priᵢ represents a battery swapping price during time period i; priᵢ₋₁ represents a battery swapping price during time period i−1; stepₚᵣᵢ represents a price step; stepₚ represents a power step; and P′_{BSS,i} represents slope of the total charging power of the battery swapping station.

Optionally, the step of determining an objective function of optimized dispatching of the electric vehicle battery swapping station according to the battery swapping price and the battery data particularly includes:

determining the objective function of the optimized dispatching of the electric vehicle battery swapping station according to the following formula:

$$max I = {I}_{R} + {I}_{P} - C = {\sum }_{i = 1}^{T} {\sum }_{m = 1}^{{D}_{i , k}} {\sum }_{k = 1}^{3} {pri}_{i} \cdot ( 1 - {SOC}_{m} ) \cdot {SOH}_{m} \cdot {Cap}_{m} + {\sum }_{i = 1}^{T} {\sum }_{m = 1}^{{D}_{i , k}} {\sum }_{k = 1}^{3} {M}_{m} \cdot R \cdot ( {SOH}_{0} - {SOH}_{m} ) - {\sum }_{i = 1}^{T} {\sum }_{n = 1}^{N} {X}_{i , n} \cdot {g}_{i} \cdot {P}_{i} \cdot Δ t where , ;$$

$${M}_{m} = \{ \begin{matrix}1 & SOH ∈ ( 0 , 80 \% ) \\ 0 & All else\end{matrix} ;$$

where, I represents the objective function; I_{R} represents an income of the battery swapping; I _{P} represents a punishment on the users; C represents a charging cost of the battery swapping station; D_{i,k} represents demand of the battery swapping during time period i after users of a k^{th} type respond to transfer of the battery swapping; k represents a type of the users, where the users are divided into three types according to the SOC of the batteries; m represents a user; SOCₘ represents an SOC of a battery of an m^{th} user; SOHₘ represents an SOH of the battery of the m^{th} user; Capₘ represents a rated capacity of the battery of the m^{th} user; Mₘ represents a punishment state of the users; R represents a unit punishment cost for users whose batteries have an SOH lower than 80%; SOH₀ represents an SOH of the batteries in the battery swapping station; gᵢ represents an electricity price; X_{i,n,} represents a charging state of an n^{th} battery in the battery swapping station during time period i; N represents a total number of the batteries in the battery swapping station; and Δt represents a unit charging time.

Optionally, the step of optimizing, according to a constraint condition and the objective function, a charging state of batteries in the battery swapping station and the demand of the battery swapping particularly includes:

optimizing, according to the constraint condition and the objective function, the charging state of the batteries in the battery swapping station and the demand of the battery swapping by means of a particle swarm optimization (PSO) algorithm;

a constraint formula of the SOH of the batteries is:

0≤SOH≤100%;

a constraint formula of the SOC of the batteries is:

0≤SOC≤100%;

a constraint formula of the demand of the battery swapping is:

D_{i,k}≤D_{i,max};

where,

$${D}_{i , k} = ⌈ \frac{{Q}_{i , k}}{{Cap}_{m} ( 1 - {SOC}_{i , k} )} ⌉$$

$${Q}_{i , k} = {Q}_{i , i} + {Q}_{i , j} = {Q}_{i , 0 , k} ( 2 + {ɛ}_{i , i} \frac{{pri}_{i} - {pri}_{i , 0}}{{pri}_{i , 0}} + {ɛ}_{i , i} \frac{{pri}_{j} - {pri}_{j , 0}}{{pri}_{j , 0}} )$$

$${Q}_{i , i} = {Q}_{i , 0 , k} ( 1 + {ɛ}_{i , i} \frac{{pri}_{i} - {pri}_{i , 0}}{{pri}_{i , 0}} )$$

$${Q}_{i , j} = {Q}_{i , 0 , k} ( 1 + {ɛ}_{i , i} \frac{{pri}_{j} - {pri}_{j , 0}}{{pri}_{j , 0}} )$$

$${ɛ}_{i , i} = \frac{Δ {Q}_{i} / {Q}_{i , 0}}{Δ {pri}_{i} / {pri}_{i , 0}} ;$$

where, D_{i,max} represents maximum demand of the battery swapping during time period i; Q_{i,k} represents total electricity demand of the battery swapping of the users of the k^{th} type during time period i; SOC_{i,k} represents an SOC of the batteries of the users of the k^{th} type during time period i; Q_{i,i} represents total electricity demand during time period i, which is generated by a price change during time period i; Q_{i,j} represents total electricity demand during time period i, which is generated by a price change during time period j; Q_{i,0,k} represents electricity demand of the users of the k^{th} type before the price change during time period i; ε_{i,i} represents a self-elasticity coefficient; ε_{i,j} represents a mutual elasticity coefficient; pri_{i,0} represents a battery swapping price before optimization during time period i; priⱼ represents a battery swapping price during time period j; ΔQᵢ represents a variation of electricity demand during time period i; Q_{i,0} represents an original electricity demand during time period i; and Δpriᵢ represents a variation of the battery swapping price during time period i;

a constraint formula of the number of the rechargeable batteries is:

$${\sum }_{i = 1}^{T} {\sum }_{n = 1}^{N} {X}_{i , n} \leq {CH}_{i , max} ;$$

where, CH_{i,max} represents a maximum number of charging piles during time period i;

constraint formulas of the battery swapping price are:

priₘᵢₙ≤priᵢ≤priₘₐₓ

P_{BSS,min}≤P_{BSS,i}≤P_{BSS,max}

Eₘᵢₙ≤Sᵢ≤Eₘₐₓ;

where, priₘᵢₙ represents a minimum price of battery swapping of the battery swapping station; priₘₐₓ represents a maximum battery swapping price of the battery swapping station; P_{BSS,min} represents minimum output power of the battery swapping station; P_{BSS,max} represents maximum output power of the battery swapping station; Eₘᵢₙ represents a minimum number of devices for the battery swapping in the battery swapping station; and Eₘₐₓ represents a maximum number of the devices for the battery swapping in the battery swapping station; and

the constraint condition further includes:

$$N - {\sum }_{i = 1}^{T} {\sum }_{n = 1}^{N} {X}_{i , n} \leq {D}_{i + 1} ;$$

where, Dᵢ₊₁ represents demand of the battery swapping during time period i+1 after the transfer of the battery swapping.

The present disclosure further provides a dispatching system for an electric vehicle battery swapping station, including:

a data acquisition module used to acquire battery data of electric vehicles and demand of battery swapping of users, where the battery data includes charging power, an SOC, an SOH, and rated capacity of batteries;

a power calculation module used to determine total charging power and average charging power of a battery swapping station according to the charging power of the batteries and the demand of the battery swapping of the users;

a module for calculating a battery swapping price, which is used to determine the battery swapping price according to the total charging power and average charging power of the battery swapping station;

an objective function determination module used to determine the objective function of optimized dispatching of the electric vehicle battery swapping station according to the battery swapping price and the battery data;

an optimization module used to optimize, according to a constraint condition and the objective function, a charging state of batteries in the battery swapping station and the demand of the battery swapping to obtain an optimized charging state of the batteries in the battery swapping station and optimized demand of the battery swapping; where, the constraint condition includes constraints on the SOH of the batteries, the SOC of the batteries, the demand of the battery swapping, the number of rechargeable batteries, and the battery swapping price; and

a module used to perform the optimized dispatching on the electric vehicle battery swapping station according to the optimized charging state of the batteries in the battery swapping station and the optimized demand of the battery swapping.

Optionally, the power calculation module is particularly used to:

determine the total charging power of the battery swapping station according to the following formula:

$${P}_{BSS , i} = {\sum }_{i = 1}^{T} {P}_{i} \cdot {S}_{i} ,$$

and

determine the average charging power of the battery swapping station according to the following formula:

$${P}_{avv} = \frac{1}{T} {\sum }_{i = 1}^{T} {P}_{i} \cdot {S}_{i} ;$$

where, P_{BSS,i} represents total charging power of the battery swapping station during time period i; Pₐᵥ represents the average charging power of the battery swapping station; Pᵢ represents charging power of the batteries during time period i; Sᵢ represents demand of the battery swapping of the users during time period i; and T represents total time.

Optionally, the module for calculating the battery swapping price is particularly used to:

determine the battery swapping price according to the following formula:

$${pri}_{i} = \{ \begin{matrix}⌊ \frac{{P}_{BSS , i} - {P}_{av}}{{step}_{p}} ⌋ \cdot {step}_{pri} + {pri}_{i - 1} & if {P}_{BSS , i} - {P}_{av} \geq {step}_{p} , {P}_{BSS , i}^{′} > 0 \\ {pri}_{i - 1} - ⌊ \frac{{P}_{BSS , i} - {P}_{av}}{{step}_{p}} ⌋ \cdot {step}_{pri} & if {P}_{BSS , i} - {P}_{av} \geq {step}_{p} , {P}_{BSS , i}^{′} < 0 \\ {pri}_{i - 1} & else\end{matrix} ;$$

where, priᵢ represents a battery swapping price during time period i; priᵢ₋₁ represents a battery swapping price during time period i−1; stepₚᵣᵢ represents a price step; stepₚ represents a power step; and P′_{BSS,i} represents slope of the total charging power of the battery swapping station.

Optionally, the objective function determination module particularly includes:

an objective function determination unit used to determine the objective function of the optimized dispatching of the electric vehicle battery swapping station according to the following formula:

$$max I = {I}_{R} + {I}_{P} - C = {\sum }_{i = 1}^{T} {\sum }_{m = 1}^{{D}_{i , k}} {\sum }_{k = 1}^{3} {pri}_{i} \cdot ( 1 - {SOC}_{m} ) \cdot {SOH}_{m} \cdot {Cap}_{m} + {\sum }_{i = 1}^{T} {\sum }_{m = 1}^{{D}_{i , k}} {\sum }_{k = 1}^{3} {M}_{m} \cdot R \cdot ( {SOH}_{0} - {SOH}_{m} ) - {\sum }_{i = 1}^{T} {\sum }_{n = 1}^{N} {X}_{i , n} \cdot {g}_{i} \cdot {P}_{i} \cdot Δ t where , ;$$

$${M}_{m} = \{ \begin{matrix}1 & SOH ∈ ( 0 , 80 \% ) \\ 0 & All else\end{matrix} \\ {X}_{i , n} = \{ \begin{matrix}1 & , Charging \\ 0 & , All else\end{matrix} ;$$

where, I represents the objective function; I_{R} represents an income of the battery swapping; I_{P} represents a punishment on the users; C represents a charging cost of the battery swapping station; D_{i,k} represents demand of the battery swapping during time period i after users of a k^{th} type respond to transfer of the battery swapping; k represents a type of the users, where the users are divided into three types according to the SOC of the batteries; m represents a user; SOCₘ represents an SOC of a battery of an m^{th} user; SOHₘ represents an SOH of the battery of the m^{th} user; Capₘ represents a rated capacity of the battery of the m^{th} user; Mₘ represents a punishment state of the users; R represents a unit punishment cost for users whose batteries have an SOH lower than 80%; SOH₀ represents an SOH of the batteries in the battery swapping station; gᵢ represents an electricity price; X_{i,n,} represents a charging state of an n^{th} battery in the battery swapping station during time period i; N represents a total number of the batteries in the battery swapping station; and Δt represents a unit charging time.

Optionally, the optimization module particularly includes:

an optimization unit used to optimize, according to the constraint condition and the objective function, the charging state of the batteries in the battery swapping station and the demand of the battery swapping by means of a PSO algorithm;

a constraint formula of the SOH of the batteries is:

0≤SOH≤100%;

a constraint formula of the SOC of the batteries is:

0≤SOC≤100%;

a constraint formula of the demand of the battery swapping is:

D_{i,k}≤D_{i,max};

$${D}_{i , k} = ⌈ \frac{{Q}_{i , k}}{{Cap}_{m} ( 1 - {SOC}_{i , k} )} ⌉$$

$${Q}_{i , k} = {Q}_{i , i} + {Q}_{i , j} = {Q}_{i , 0 , k} ( 2 + {ɛ}_{i , i} \frac{{pri}_{i} - {pri}_{i , 0}}{{pri}_{i , 0}} + {ɛ}_{i , i} \frac{{pri}_{j} - {pri}_{j , 0}}{{pri}_{j , 0}} )$$

$${Q}_{i , i} = {Q}_{i , 0 , k} ( 1 + {ɛ}_{i , i} \frac{{pri}_{i} - {pri}_{i , 0}}{{pri}_{i , 0}} )$$

$${Q}_{i , j} = {Q}_{i , 0 , k} ( 1 + {ɛ}_{i , i} \frac{{pri}_{j} - {pri}_{j , 0}}{{pri}_{j , 0}} )$$

$${ɛ}_{i , i} = \frac{Δ {Q}_{i} / {Q}_{i , 0}}{Δ {pri}_{i} / {pri}_{i , 0}} ;$$

where, D_{i,max} represents maximum demand of the battery swapping during time period i; D_{i,k} represents total electricity demand of the battery swapping of the users of the k^{th} type during time period i; SOC_{i,k} represents an SOC of the batteries of the users of the k^{th} type during time period i; Q_{i,i} represents total electricity demand during time period i, which is generated by a price change during time period i; Q_{i,j} represents total electricity demand during time period i, which is generated by a price change during time period j; Q_{i,0,k} represents electricity demand of the users of the k^{th} type before the price change during time period i; ε_{i,i} represents a self-elasticity coefficient; ε_{i,j} represents a mutual elasticity coefficient; pri_{i,0} represents a battery swapping price before optimization during time period i; priⱼ represents a battery swapping price during time period j; ΔQᵢ represents a variation of electricity demand during time period i; Q_{i,0} represents an original electricity demand during time period i; and Δpriᵢ represents a variation of the battery swapping price during time period i;

a constraint formula of the number of the rechargeable batteries is:

$${\sum }_{i = 1}^{T} {\sum }_{n = 1}^{N} {X}_{i , n} \leq {CH}_{i , max} ;$$

where, CH_{i,max} represents a maximum number of charging piles during time period i;

constraint formulas of the battery swapping price are:

priₘᵢₙ≤priᵢ≤priₘₐₓ

P_{BSS,min}≤P_{BSS,i}≤P_{BSS,max}

Eₘᵢₙ≤Sᵢ≤Eₘₐₓ;

where, priₘᵢₙ represents a minimum battery swapping price of the battery swapping station; priₘₐₓ represents a maximum battery swapping price of the battery swapping station; P_{BSS,min} represents minimum output power of the battery swapping station; P_{BSS,max} represents maximum output power of the battery swapping station; Eₘᵢₙ represents a minimum number of devices for the battery swapping in the battery swapping station; and Eₘₐₓ represents a maximum number of the devices for the battery swapping in the battery swapping station; and

the constraint condition further includes:

$$N - {\sum }_{i = 1}^{T} {\sum }_{n = 1}^{N} {X}_{i , n} \leq {D}_{i + 1} ;$$

where, Dᵢ₊₁ represents demand of the battery swapping during time period i+1 after the transfer of the battery swapping.

Compared with the prior art, the present disclosure has the following beneficial effects:

Total charging power and average charging power of a battery swapping station are determined according to charging power of batteries and demand of battery swapping of users; a battery swapping price is determined according to the total charging power and average charging power of the battery swapping station; an objective function of optimized dispatching of the electric vehicle battery swapping station is determined according to the battery swapping price and battery data; a charging state of batteries in the battery swapping station and the demand of the battery swapping are optimized according to a constraint condition and the objective function to obtain an optimized charging state of the batteries in the battery swapping station and optimized demand of the battery swapping; and the optimized dispatching is performed on the electric vehicle battery swapping station according to the optimized charging state of the batteries in the battery swapping station and the optimized demand of the battery swapping. Therefore, the dispatching method and system for an electric vehicle battery swapping station of the present disclosure can achieve ordered battery charging and battery swapping of the electric vehicles, thus increasing the income of the battery swapping station and improving the effects of peak shaving and valley filling of a power system.

### BRIEF DESCRIPTION OF DRAWINGS

For the sake of a clearer explanation of the embodiments of the present disclosure or the technical solutions of the prior art, the accompanying drawings required by the embodiments will be described briefly below. Clearly, the following accompanying drawings merely illustrate some embodiments of the present disclosure, and other accompanying drawings can also be obtained by those ordinarily skilled in the art based on the following ones without creative efforts.

FIG. 1 is a flow chart of a dispatching method for an electric vehicle battery swapping station in an embodiment of the present disclosure;

FIG. 2 is a schematic diagram of an optimized dispatching framework of a battery swapping station in the embodiment of the present disclosure;

FIG. 3 is a flow chart of a particle swarm optimization (PSO) algorithm in the embodiment of the present disclosure;

FIG. 4 is a graph showing convergence of iteration of an income of the battery swapping station in the embodiment of the present disclosure; and

FIG. 5 is a structural block diagram of a dispatching system for an electric vehicle battery swapping station in an embodiment of the present disclosure.

### DETAILED DESCRIPTION

The technical solutions of the embodiments of the present disclosure are clearly and completely described below with reference to the accompanying drawings. Apparently, the embodiments in the following descriptions are only illustrative ones, and are not all possible ones of the present disclosure. All other embodiments obtained by those ordinarily skilled in the art based on the embodiments of the present disclosure without creative efforts should also fall within the protection scope of the present disclosure.

The objective of the present disclosure is to provide a dispatching method and system for an electric vehicle battery swapping station, which can achieve ordered battery charging and battery swapping of the electric vehicles, thus improving the effects of peak shaving and valley filling of a power system.

To make the foregoing objective, features, and advantages of the present disclosure clearer and more comprehensible, the present disclosure is further described in detail below with reference to the accompanying drawings and specific embodiments.

### Embodiments

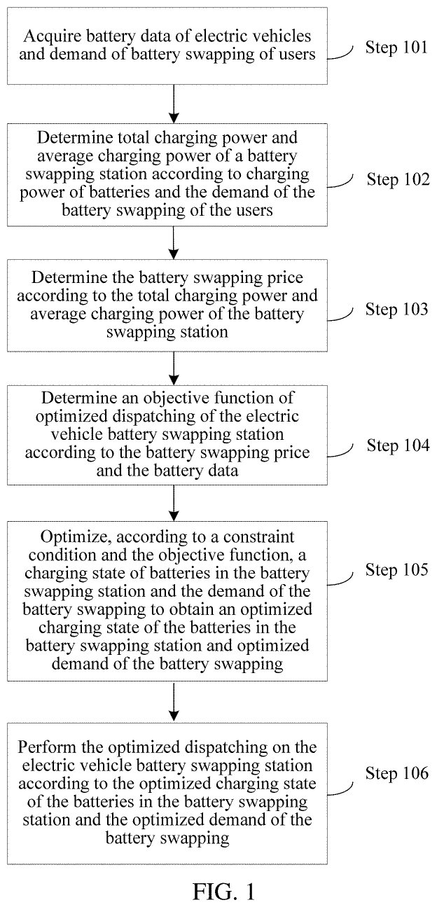

FIG. 1 shows a flow chart of a dispatching method for an electric vehicle battery swapping station in an embodiment of the present disclosure. As shown in FIG. 1, the dispatching method for an electric vehicle battery swapping station includes:

Step 101: acquire battery data of electric vehicles and demand of battery swapping of users, where the battery data includes charging power, state of charge (SOC), state of health (SOH), and rated capacity of batteries.

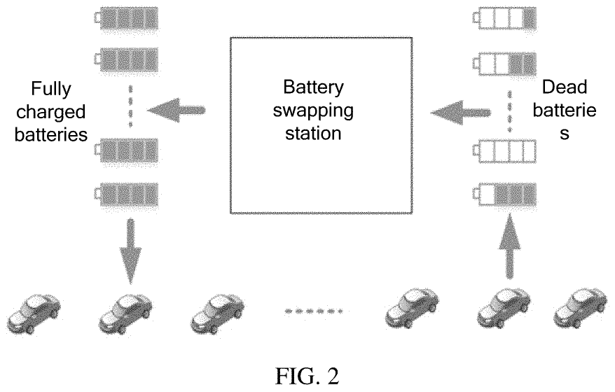

FIG. 2 shows a schematic diagram of an optimized dispatching framework of a battery swapping station. As an energy supply station for the electric vehicles, the battery swapping station is used to swap dead batteries of the users for fully charged batteries and charge the dead batteries. Because battery charging and battery swapping of the electric vehicles can be performed anytime, it is necessary to lead, through a proper price, the users to perform the battery charging and the battery swapping, so as to guarantee safety of operation of a whole power system.

Different users have different responsivity on a battery swapping price; and in view of this, the users are classified as users of a first type, users of a second type, and users of a third type according to the SOC of the batteries:

$$SOC = \{ \begin{matrix}[ 0 , & 30 ] & users of a first type \\ [ 30 \% , & 60 ] & users of a second type . \\ [ 60 \% , & 100 \% ] & users of a third type\end{matrix}$$

The batteries of the electric vehicles are continuously recycled between the battery swapping station and the users. Due to continuous charging, discharging, breakage, and aging, the batteries have an available capacity gradually reduced. The SOH of the batteries is:

$${SOH}_{m} = \frac{{B}_{m}}{{Cap}_{m}} \times 1 \; 00 \% ;$$

Where, SOHₘ represents an SOH of a battery of an m^{th} user; Capₘ represents a rated capacity of the battery of the m^{th} user; and Bₘ represents an available capacity of the battery of the m^{th} user.

If an SOH of batteries in the battery swapping station is lower than 80%, these batteries will not be swapped to the users any longer; if an SOH of batteries of the users is lower than 80%, the users will be punished; and in this way, potential damage caused by the users to these batteries can be avoided.

$$SOH = \{ \begin{matrix}[ 80 \% , & 100 \% ] \\ [ 0 , & 80 \% ]\end{matrix}$$

normal battery swapping in a battery swapping station maintenance and other processing in a battery swapping station

Step 102: determine total charging power and average charging power of the battery swapping station according to the charging power of the batteries and the demand of the battery swapping of the users.

Step 102 particularly includes:

Determine the total charging power of the battery swapping station according to the following formula:

$${P}_{BSS , i} = {\sum }_{i = 1}^{T} {P}_{i} \cdot {S}_{i} ;$$

and

Determine the average charging power of the battery swapping station according to the following formula:

$${P}_{av} = \frac{1}{T} {\sum }_{i = 1}^{T} {P}_{i} \cdot {S}_{i}$$

Where, P_{BSS,i} represents total charging power of the battery swapping station during time period i; Pₐᵥ represents the average charging power of the battery swapping station; Pᵢ represents charging power of the batteries during time period i; Sᵢ represents demand of the battery swapping of the users during time period i; and T represents total time.

Step 103: determine the battery swapping price according to the total charging power and average charging power of the battery swapping station.

Step 103 particularly includes:

Determine the battery swapping price according to the following formula:

$${pri}_{i} = \{ \begin{matrix}⌊ \frac{{P}_{BSS , i} - {P}_{av}}{{step}_{p}} ⌋ \cdot {step}_{pri} + {pri}_{i - 1} & if {P}_{BSS , i} - {P}_{av} \geq {step}_{p} , {P}_{BSS , i}^{′} > 0 \\ {pri}_{i - 1} - ⌊ \frac{{P}_{BSS , i} - {P}_{av}}{{step}_{p}} ⌋ \cdot {step}_{pri} & if {P}_{BSS , i} - {P}_{av} \geq {step}_{p} , {P}_{BSS , i}^{′} < 0 \\ {pri}_{i - 1} & else\end{matrix} ;$$

Where, priᵢ represents a battery swapping price during time period i; priᵢ₋₁ represents a battery swapping price during time period i−1; stepₚᵣᵢ represents a price step; stepₚ represents a power step; and P′_{BSS,i} represents slope of the total charging power of the battery swapping station.

Due to uncertainty of an external environment and different cognition and processing abilities of the users on information, there is a cognitive bias and preference during decision-making of the users. The users generate a voluntary response willingness by considering a cost and an SOH of batteries to be swapped, and the voluntary response willingness can express the responsivity:

r_{n,k}=w₁·SOH_{n,k}+w₂·θ_{n,k} k=1,2,3 n=1,2 . . . N

w₁+w₂=1

Where, r_{n,k} represents a response willingness of an n^{th} user of a k^{th} type; and w₂ represent weighting factors; θ_{n,k} represents satisfaction of the n^{th} user of the k^{th} type on an incurred expense; N represents a total number of the batteries in the battery swapping station; and SOH_{n,k} represents an SOH of a battery of the n^{th} user of the k^{th} type.

Under an influence of the battery swapping price, whether or not the users respond to transfer of the battery swapping is determined according to their experience. The users can voluntarily select weighting factors. If the users select batteries with a good SOH, w₁ is a large value, and w₂ is a small value; and if the users select batteries with high user satisfaction on the incurred expense, w₁ is a small value, and w₂ is a large value. In this way, user satisfaction on battery swapping service can be guaranteed by voluntary selection of the users.

The user satisfaction on the incurred expenses is:

$$θ = \frac{{C}_{i , 0} - {C}_{i}}{{C}_{i , 0}}$$

$${C}_{i , 0} = {pri}_{i , 0} \cdot ( 1 - SOC ) \cdot SOH \cdot {Cap}_{j}$$

$${C}_{i} = {pri}_{i} \cdot ( 1 - SOC ) \cdot SOH \cdot {Cap}_{j} ;$$

Where, C_{i,0} represents a cost of the battery swapping before optimization; Cᵢ represents a cost of the battery swapping during the optimization; pri_{i,0} represents a battery swapping price before the optimization; and Capⱼ represents a rated capacity of the batteries.

Integer variables of 0-1 are adopted to express that the users respond to and do not respond to the transfer of the battery swapping. When a value of the response willingness of the users is greater than a response threshold, a state of the users is expressed by a binary variable 1; and otherwise a state of the users is expressed by 0. A state model of the users is:

$${x}_{i , k} = \{ \begin{matrix}1 & if {r}_{i , k} \\ 0 & else ,\end{matrix} > δ ,$$

respond to transfer of battery swapping not respond to transfer of battery swapping

$${D}_{i , k}^{′} = {\sum }_{i}^{{S}_{i , K}} {x}_{i , k} ;$$

Where, x_{i,k} represents a state of users who respond to the transfer of the battery swapping; δ represents a response threshold of the users; D_{i,k} represents demand of the battery swapping of users of the k^{th} type, who do not respond to the transfer of the battery swapping; and S_{i,K} represents a total number of the users of the k^{th} type.

Due to different cognition and processing abilities of the users on the information, there is the cognitive bias and preference during the decision-making of the users. Part of users respond to the transfer of the battery swapping, and the rest of users do not respond to the transfer of the battery swapping and leave from the battery swapping station, so that a degree of participation of the users is expressed by user responsivity.

The user responsivity refers to a ratio of users participating in optimized dispatching to all users, and indicates a degree of participation of the users in an optimal model.

The user responsivity is:

$${r}_{i} = \frac{{D}_{i}^{′}}{{S}_{i}} \cdot 100$$

$${D}_{i}^{′} = {D}_{i , k = 1}^{′} + {D}_{i , k = 2}^{′} + {D}_{i , k = 3}^{′}$$

$${S}_{i} = {S}_{i , k = 1} + {S}_{i , k = 2} + {S}_{i , k = 1} ;$$

Where, rᵢ represents user responsivity during time period i; D′ᵢ represents the number of batteries of three types of users responding to the transfer of the battery swapping during time period i; and Sᵢ represents total demand of the battery swapping of the three types of users during time period i.

The transfer of the battery swapping of the electric vehicles is determined by a price elasticity coefficient, a self-elasticity coefficient, and a mutual elasticity coefficient, and thus a transfer rate of the battery swapping is defined.

The transfer of the battery swapping of the electric vehicles refers to that the users change time of the battery swapping under the influence of the price, that is, the battery swapping is transferred from current time to other time to be performed or from the other time to the current time to be performed.

The price elasticity coefficient indicates a responsivity index of demand on a price change, and is a ratio of the percentage of a demand change to the percentage of the price change.

The self-elasticity coefficient indicates an influence of the price change during certain time on electricity demand during the same time:

$${ɛ}_{i , i} = \frac{Δ {Q}_{i} / {Q}_{i , 0}}{Δ {pri}_{i} / {pri}_{i , 0}} ;$$

Where, ε_{i,i} represents the self-elasticity coefficient; ΔQᵢ represents a variation of electricity demand during time period i; Q_{i,0} represents original electricity demand during time period i; Δpriᵢ represents a variation of the battery swapping price during time period i; and pri_{i,0} represents the battery swapping price before the optimization.

The mutual elasticity coefficient indicates an influence of a price change during time period j on the electricity demand during time period i:

$${ɛ}_{i , j} = \frac{Δ {Q}_{i} / {Q}_{i , 0}}{Δ {pri}_{j} / {pri}_{j , 0}} ;$$

Where, ε_{i,j} represents the mutual elasticity coefficient; pri_{j,0} represents a battery swapping price before the optimization during time period j; and Δpriⱼ represents a variation of the battery swapping price during time period j.

The time is divided into a peak period, a mid peak period, and a valley period, and different users have different responsivity on the battery swapping price, so that nonzero elements in elasticity matrixes E are variously distributed. The elasticity matrixes E of the three types of users are:

$${E}_{k = 1} = [ \begin{matrix}{ɛ}_{1 , 1} & 0 & 0 \\ 0 & {ɛ}_{2 , 2} & 0 \\ 0 & 0 & {ɛ}_{3 , 3}\end{matrix} ]$$

$${E}_{k = 2} = [ \begin{matrix}{ɛ}_{1 , 1} & {ɛ}_{1 , 2} & 0 \\ {ɛ}_{2 , 1} & {ɛ}_{2 , 2} & {ɛ}_{2 , 3} \\ 0 & {ɛ}_{3 , 2} & {ɛ}_{3 , 3}\end{matrix} ]$$

$${E}_{k = 3} = [ \begin{matrix}{ɛ}_{1 , 1} & {ɛ}_{1 , 2} & {ɛ}_{1 , 3} \\ {ɛ}_{2 , 1} & {ɛ}_{2 , 2} & {ɛ}_{2 , 3} \\ {ɛ}_{3 , 1} & {ɛ}_{3 , 2} & {ɛ}_{3 , 3}\end{matrix} ] ;$$

Where, Eₖ₌₁, Eₖ₌₂, and Eₖ₌₃ respectively represent price elasticity matrixes of the users of the first type, the users of the second type, and the users of the third type.

Thus, electricity demand during time period i, which is generated by a price change during time period i, is:

$${Q}_{i , i} = {Q}_{i , 0 , k} ( 1 + {ɛ}_{i , i} \frac{{pri}_{j} - {pri}_{j , 0}}{{pri}_{j , 0}} ) .$$

and

The electricity demand during time period i, which is generated by the price change during time period j, is:

$${Q}_{i , j} = {Q}_{i , 0 , k} ( 1 + {ɛ}_{i , i} \frac{p r {i}_{j} - p r {i}_{j , 0}}{p r {i}_{j , 0}} ) .$$

Total electricity demand during time period i is obtained by adding the electricity demand during time period i, which is generated by the price change during time period i, to the electricity demand during time period i, which is generated by the price change during time period j, and the total electricity demand during time period i, which is generated by the price changes, is:

$${Q}_{i , k} = {Q}_{i , i} + {Q}_{i , j} = {Q}_{i , 0 , k} ( 2 + {ɛ}_{i , i} \frac{p r {i}_{i} - p r {i}_{i , 0}}{p r {i}_{i , 0}} + {ɛ}_{i , i} \frac{p r {i}_{j} - p r {i}_{j , 0}}{p r {i}_{j , 0}} ) ;$$

Where, Q_{i,k} represents total electricity demand of the battery swapping of the users of the k^{th} (type during time period i; Q_{i,i} represents total electricity demand during time period i, which is generated by the price change during time period i; Q_{i,j} represents total electricity demand during time period i, which is generated by the price change during time period j; and Q_{i,0,k} represents electricity demand of the users of the k^{th} type before the price change during time period i.

The obtained total electricity demand is converted into the demand of the battery swapping, that is, the demand of the battery swapping is redistributed by means of the elasticity matrixes under the battery swapping price; and the demand of the battery swapping during each time is:

$${D}_{i , k} = ⌈ \frac{{Q}_{i , k}}{C a {p}_{j} ( 1 - S O {C}_{i , k} )} ⌉ ;$$

Where, D_{i,k} represents demand of the battery swapping during time period i after the users of the k^{th} type respond to the transfer of the battery swapping; SOC_{i,k} represents an SOC of batteries of the users of the k^{th} type during time period i.

Total demand of the battery swapping of the three types of users in a whole day is:

$${N}_{k = 1} = {\sum }_{i = 1}^{T} {D}_{i , k = 1} \\ {N}_{k = 2} = {\sum }_{i = 1}^{T} {D}_{i , k = 2} \\ {N}_{k = 3} = {\sum }_{i = 1}^{T} {D}_{i , k = 3} ;$$

Where, Nₖ₌₁, Nₖ₌₂, and Nₖ₌₃ respectively represent the number of users of the k^{th} type, who responding to the transfer of the battery swapping, in a whole day.

By overall considering a price during the current time and a price during the other time, the users select the most favorable time for the battery swapping; and the transfer rate of the battery swapping is defined to express a degree of the users transferring the battery swapping from the current time to the other time or from the other time to the current time.

The transfer rate of the battery swapping is:

$${F}_{i} = \frac{\vert {D}_{i} - {D}_{i}^{′} \vert}{{D}_{i}^{′}} \cdot 100 \% ;$$

Where, Fᵢ represents a transfer rate of the users; Dᵢ represents total demand of the battery swapping during time period i after transfer of the three types of users; and D′ᵢ represents the number of the batteries of three types of users responding to the transfer of the battery swapping during time period i.

A constraint condition and objective function of an income of the battery swapping station: it is necessary to consider an income of the battery swapping of the battery swapping station, a charging cost of the battery swapping station, and a punishment cost for the users; and a utility function aiming at maximizing the income of the battery swapping station is established, and a charging state of the batteries in the battery swapping station is taken as an optimization variable.

Step 104: determine an objective function of the optimized dispatching of the electric vehicle battery swapping station according to the battery swapping price and the battery data.

Step 104 particularly includes:

Determine the objective function of the optimized dispatching of the electric vehicle battery swapping station according to the following formula:

$$max I = {I}_{R} + {I}_{P} - C = {\sum }_{i = 1}^{T} {\sum }_{m = 1}^{{D}_{i , k}} {\sum }_{k = 1}^{3} p r {i}_{i} \cdot ( 1 - S O {C}_{m} ) \cdot S O {H}_{m} \cdot {Cap}_{m} + {\sum }_{i = 1}^{T} {\sum }_{m = 1}^{{D}_{i , k}} {\sum }_{k = 1}^{3} {M}_{m} \cdot R \cdot ( S O {H}_{0} - S O {H}_{m} ) - {\sum }_{i = 1}^{T} {\sum }_{n = 1}^{N} {X}_{i , n} \cdot {g}_{i} \cdot {P}_{i} \cdot Δ t ;$$

Where,

$${M}_{m} = \{ \begin{matrix}1 & SOH ∈ ( 0.80 \% ) \\ 0 & All else\end{matrix} \\ {X}_{i , n ,} = \{ \begin{matrix}1 , & Charging \\ 0 , & All else\end{matrix} ;$$

Where, I represents the objective function; I_{R} represents the income of the battery swapping; I_{P} represents a punishment on the users; C represents the charging cost of the battery swapping station; D_{i,k} represents the demand of the battery swapping during time period i after the users of the k^{th} type respond to the transfer of the battery swapping; k represents a type of the users, where the users are divided into three types according to the SOC of the batteries; m represents a user; SOCₘ represents an SOC of the battery of the m^{th} user; SOHₘ represents the SOH of the battery of the m^{th} user; Capₘ represents the rated capacity of the battery of the m^{th} user; Mₘ represents a punishment state of the users; R represents a unit punishment cost for users whose batteries have an SOH lower than 80%; SOH₀ represents an SOH of the batteries in the battery swapping station; gᵢ represents an electricity price; X_{i,n,} represents a charging state of an n^{th} battery in the battery swapping station during time period i; N represents the total number of the batteries in the battery swapping station; and Δt represents a unit charging time.

Step 105: optimize, according to the constraint condition and the objective function, the charging state of the batteries in the battery swapping station and the demand of the battery swapping to obtain an optimized charging state of the batteries in the battery swapping station and optimized demand of the battery swapping; where, the constraint condition includes constraints on the SOH of the batteries, the SOC of the batteries, the demand of the battery swapping, the number of rechargeable batteries, and the battery swapping price.

Step 105 particularly includes:

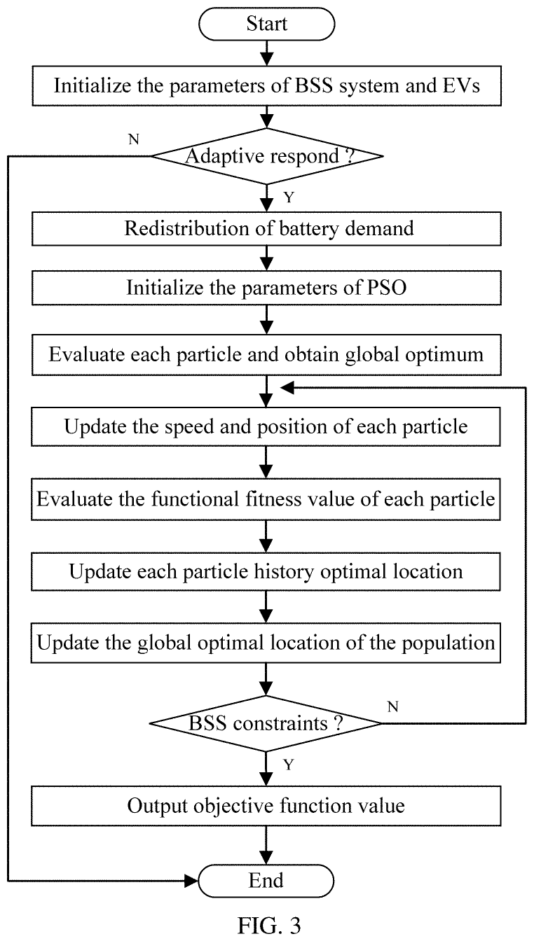

Optimize, according to the constraint condition and the objective function, the charging state of the batteries in the battery swapping station and the demand of the battery swapping by means of a PSO algorithm;

Where, as shown in FIG. 3, the PSO algorithm is particularly performed through the following steps: initialize parameters of the battery swapping station first; then determine whether or not the users respond to the transfer of the battery swapping; afterwards, redistribute the demand of the battery swapping by means of the elasticity matrixes; and finally, with the income of the battery swapping station as a fitness value of a particle swarm as well as the charging state of the batteries as the optimization variable, select global optimization, namely properly optimized dispatching of the batteries, through a change to positions and speeds of particles, and then perform optimal dispatching by means of a matrix laboratory (MATLAB). In this way, optimal battery swapping and optimal battery charging as final optimization results are achieved. The optimal battery swapping refers to the demand of the battery swapping during each time, namely D_{i,k}; and the optimal battery charging refers to a proper arrangement on charging time of the batteries in the battery swapping station, namely X_{i,n,}.

A constraint formula of the SOH, constrained from 0% to 100%, of the batteries is:

0≤SOH≤100%;

A constraint formula of the SOC, constrained from 0% to 100%, of the batteries is:

0≤SOC≤100%; and

A constraint formula of the demand, less than the maximum supply demand of the battery swapping, of the battery swapping is:

D_{i,k}≤D_{i,max};

Where,

$${D}_{i , k} = ⌈ \frac{{Q}_{i , k}}{C a {p}_{m} ( 1 - S O {C}_{i , k} )} ⌉$$

$${Q}_{i , k} = {Q}_{i , i} + {Q}_{i , j} = {Q}_{i , 0 , k} ( 2 + {ɛ}_{i , i} \frac{p r {i}_{i} - p r {i}_{i , 0}}{p r {i}_{i , 0}} + {ɛ}_{i , i} \frac{p r {i}_{j} - p r {i}_{j , 0}}{p r {i}_{j , 0}} )$$

$${Q}_{i , i} = {Q}_{i , 0 , k} ( 1 + {ɛ}_{i , i} \frac{p r {i}_{i} - p r {i}_{i , 0}}{p r {i}_{i , 0}} )$$

$${Q}_{i , j} = {Q}_{i , 0 , k} ( 1 + {ɛ}_{i , i} \frac{p r {i}_{j} - p r {i}_{j , 0}}{p r {i}_{j , 0}} )$$

$${ɛ}_{i , i} = \frac{Δ {Q}_{i} / {Q}_{i , 0}}{Δ p r {i}_{i} / p r {i}_{i , 0}}$$

$${ɛ}_{i . j} = \frac{Δ {Q}_{i} / {Q}_{i , 0}}{Δ p r {i}_{j} / p r {i}_{j , 0}} ;$$

Where, D_{i,max} represents the maximum demand of the battery swapping during time period i; Q_{i,k} represents the total electricity demand of the battery swapping of the users of the k^{th} type during time period i; SOC_{i,k} represents the SOC of the batteries of the users of the k^{th} type during time period i; Q_{i,i} represents the total electricity demand during time period i, which is generated by the price change during time period i; Q_{i,j} represents the total electricity demand during time period i, which is generated by the price change during time period j; Q_{i,0,k} represents the electricity demand of the users of the k^{th} type before the price change during time period i; ε_{i,i} represents the self-elasticity coefficient; ε_{i,j} represents the mutual elasticity coefficient; pri_{i,0} represents the battery swapping price before the optimization during time period i; pri_{j,0} represents the battery swapping price before the optimization during time period j; priⱼ represents a battery swapping price during time period j; ΔQᵢ represents the variation of the electricity demand during time period i; Q_{i,0} represents the original electricity demand during time period i; Δpriᵢ represents the variation of the battery swapping price during time period i; and Δpriⱼ represents the variation of the battery swapping price during time period j.

A constraint formula of the number, less than that of charging piles in the battery swapping station, of the rechargeable batteries is:

$${\sum }_{i = 1}^{T} {\sum }_{n = 1}^{N} {X}_{i , n} \leq C {H}_{i , max} ;$$

Where, CH_{i,max} represents the maximum number of the charging piles during time period i.

Constraint formulas of the battery swapping price are:

priₘᵢₙ≤priᵢ≤priₘₐₓ

P_{BSS,min}≤P_{BSS,i}≤P_{BSS,max}

Eₘᵢₙ≤Sᵢ≤Eₘₐₓ;

Where, priₘᵢₙ represents the minimum battery swapping price of the battery swapping station; priₘₐₓ represents the maximum battery swapping price of the battery swapping station; P_{BSS,min} represents the minimum output power of the battery swapping station; P_{BSS,max} represents the maximum output power of the battery swapping station; Eₘᵢₙ represents the minimum number of devices for the battery swapping in the battery swapping station; and Eₘₐₓ represents the maximum number of the devices for the battery swapping in the battery swapping station.

The constraint condition further includes:

A constraint on demand of the battery swapping during next time i+1, swapping demand of fully charged batteries during the current time is greater than that of the fully charged batteries during the next time. A constraint formula is:

$$N - {\sum }_{i = 1}^{T} {\sum }_{n = 1}^{N} {X}_{i , n} \leq {D}_{i + 1} ;$$

Where, Dᵢ₊₁ represents demand of the battery swapping during time period i+1 after the transfer of the battery swapping.

Step 106: perform the optimized dispatching on the electric vehicle battery swapping station according to the optimized charging state of the batteries in the battery swapping station and the optimized demand of the battery swapping.

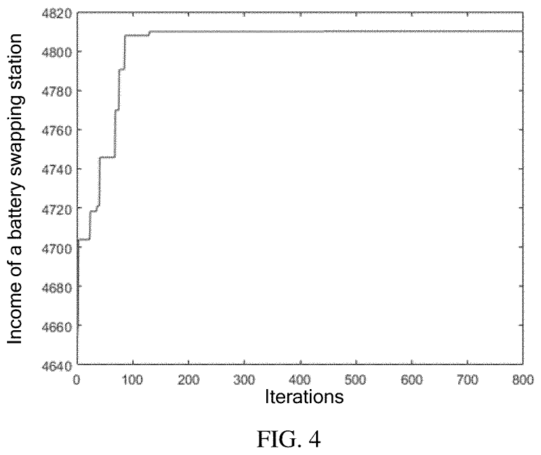

As shown in FIG. 4, the optimized dispatching method for a battery swapping station of the present disclosure can achieve ordered battery charging and battery swapping of the electric vehicles, thus increasing the income of the battery swapping station and realizing peak shaving and valley filling of the power system.

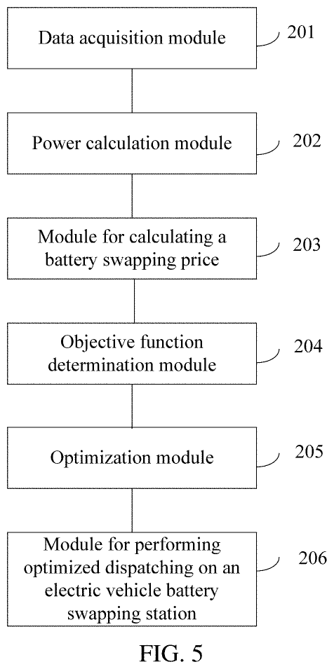

FIG. 5 shows a structural block diagram of a dispatching system for an electric vehicle battery swapping station in an embodiment of the present disclosure. As shown in FIG. 5, the dispatching system for an electric vehicle battery swapping station includes a data acquisition module 201, a power calculation module 202, a module 203 for calculating a price of battery swapping, an objective function determination module 204, an optimization module 205, and a module 206 for performing optimized dispatching on an electric vehicle battery swapping station.

The data acquisition module 201 is used to acquire battery data of the electric vehicles and demand of the battery swapping of users, where the battery data includes charging power, an SOC, an SOH, and rated capacity of batteries.

The power calculation module 202 is used to determine total charging power and average charging power of the battery swapping station according to the charging power of the batteries and the demand of the battery swapping of the users.

The power calculation module is particularly used to:

determine the total charging power of the battery swapping station according to the following formula:

$${P}_{B S S , i} = {\sum }_{i = 1}^{T} {P}_{i} \cdot {S}_{i} ,$$

and

determine the average charging power of the battery swapping station according to the following formula:

$${P}_{a v} = \frac{1}{T} {\sum }_{i = 1}^{T} {P}_{i} \cdot {S}_{i} ;$$

Where, P_{BSS,i} represents total charging power of the battery swapping station during time period i; Pₐᵥ represents the average charging power of the battery swapping station; Pᵢ represents charging power of the batteries during time period i; Sᵢ represents demand of the battery swapping of the users during time period i; and T represents total time.

The module 203 for calculating the battery swapping price is used to determine the battery swapping price according to the total charging power and average charging power of the battery swapping station.

The module 203 for calculating the battery swapping price is particularly used to:

determine the battery swapping price according to the following formula:

$${pri}_{i} = \{ \begin{matrix}⌊ \frac{{P}_{B S S , i} - {P}_{av}}{{step}_{p}} ⌋ \cdot {step}_{pri} + {pri}_{i - 1} & if {P}_{B S S , i} - {P}_{av} \geq {step}_{p} , & {P}_{B S S , i}^{′} > 0 \\ {pri}_{i - 1} - ⌊ \frac{{P}_{B S S , i} - {P}_{av}}{{step}_{p}} ⌋ \cdot {step}_{pri} & if {P}_{B S S , i} - {P}_{av} \geq {step}_{p} , & {P}_{B S S , i}^{′} < 0 \\ {pri}_{i - 1} & else & \end{matrix} ;$$

Where, priᵢ represents a battery swapping price during time period i; priᵢ₋₁ represents a battery swapping price during time period i−1; stepₚᵣᵢ represents a price step; stepₚ represents a power step; and P′_{BSS,i} represents slope of the total charging power of the battery swapping station.

The objective function determination module 204 is used to determine the objective function of the optimized dispatching of the electric vehicle battery swapping station according to the battery swapping price and the battery data.

The objective function determination module 204 particularly includes:

An objective function determination unit used to determine the objective function of the optimized dispatching of the electric vehicle battery swapping station according to the following formula:

$$max I = {I}_{R} + {I}_{P} - C = {\sum }_{i = 1}^{T} {\sum }_{m = 1}^{{D}_{i , k}} {\sum }_{k = 1}^{3} p r {i}_{i} \cdot ( 1 - S O {C}_{m} ) \cdot S O {H}_{m} \cdot {Cap}_{m} + {\sum }_{i = 1}^{T} {\sum }_{m = 1}^{{D}_{i . k}} {\sum }_{k = 1}^{3} {M}_{m} \cdot R \cdot ( S O {H}_{0} - S O {H}_{m} ) - {\sum }_{i = 1}^{T} {\sum }_{n = 1}^{N} {X}_{i , n} \cdot {g}_{i} {P}_{i} \cdot Δ t ;$$

$$Where , \\ {M}_{m} = \{ \begin{matrix}1 & S O H ∈ ( 0.80 \% ) \\ 0 & All else\end{matrix} \\ {X}_{i , n ,} = \{ \begin{matrix}1 , & Charging \\ 0 , & All else\end{matrix} ;$$

Where, I represents the objective function; I_{R} represents an income of the battery swapping; I_{P} represents a punishment on the users; C represents a charging cost of the battery swapping station; D_{i,k} represents demand of the battery swapping during time period i after users of a k^{th} type respond to transfer of the battery swapping; k represents a type of the users, where the users are divided into three types according to the SOC of the batteries; m represents a user; SOCₘ represents an SOC of a battery of an m user; SOH ₘ represents an SOH of the battery of the m^{th} user; Capₘ represents a rated capacity of the battery of the m^{th} user; Mₘ represents a punishment state of the users; R represents a unit punishment cost for users whose batteries have an SOH lower than 80%; SOH₀ represents an SOH of batteries in the battery swapping station; gᵢ represents an electricity price; X_{i,n,} represents a charging state of an n^{th} battery in the battery swapping station during time period i; N represents a total number of the batteries in the battery swapping station; and Δt represents a unit charging time.

The optimization module 205 is used to optimize, according to a constraint condition and the objective function, a charging state of the batteries in the battery swapping station and the demand of the battery swapping to obtain an optimized charging state of the batteries in the battery swapping station and optimized demand of the battery swapping; where, the constraint condition includes constraints on the SOH of the batteries, the SOC of the batteries, the demand of the battery swapping, the number of rechargeable batteries, and the battery swapping price.

The optimization module 205 particularly includes:

An optimization unit used to optimize, according to the constraint condition and the objective function, the charging state of the batteries in the battery swapping station and the demand of the battery swapping by means of a PSO algorithm.

A constraint formula of the SOH of the batteries is:

0≤SOH≤100%;

A constraint formula of the SOC of the batteries is:

0≤SOC≤100%; and

A constraint formula of the demand of the battery swapping is:

D_{i,k}≤D_{i,max};

Where,

$${D}_{i , k} = ⌈ \frac{{Q}_{i , k}}{C a {p}_{m} ( 1 - S O {C}_{i , k} )} ⌉$$

$${Q}_{i , k} = {Q}_{i , i} + {Q}_{i , j} = {Q}_{i , 0 , k} ( 2 + {ɛ}_{i , i} \frac{p r {i}_{i} - p r {i}_{i , 0}}{p r {i}_{i , 0}} + {ɛ}_{i , i} \frac{p r {i}_{j} - p r {i}_{j , 0}}{p r {i}_{j , 0}} )$$

$${Q}_{i , i} = {Q}_{i , 0 , k} ( 1 + {ɛ}_{i , i} \frac{p r {i}_{i} - p r {i}_{i , 0}}{p r {i}_{i , 0}} )$$

$${Q}_{i , j} = {Q}_{i , 0 , k} ( 1 + {ɛ}_{i , i} \frac{p r {i}_{j} - p r {i}_{j , 0}}{p r {i}_{j , 0}} )$$

$${ɛ}_{i , i} = \frac{Δ {Q}_{i} / {Q}_{i , 0}}{Δ p r {i}_{i} / p r {i}_{i , 0}}$$

$${ɛ}_{i , j} = \frac{Δ {Q}_{i} / {Q}_{i , 0}}{Δ p r {i}_{j} / p r {i}_{j , 0}} ;$$

Where, D_{i,max} represents the maximum demand of the battery swapping during time period i; Q_{i,k} represents total electricity demand of the battery swapping of the users of the k^{th} type during time period i; SOC_{i,k} represents an SOC of the batteries of the users of the k^{th} type during time period i; Q_{i,i} represents total electricity demand during time period i, which is generated by a price change during time period i; Q_{i,j} represents total electricity demand during time period i, which is generated by a price change during time period j; Q_{i,0,k} represents electricity demand of the users of the k^{th} type before the price change during time period i; ε_{i,i} represents a self-elasticity coefficient; ε_{i,j} represents a mutual elasticity coefficient; pri_{i,0} represents a battery swapping price before optimization during time period i; pri_{j,0} represents a battery swapping price before optimization during time period j; priⱼ represents a battery swapping price during time period j; ΔQᵢ represents a variation of the electricity demand during time period i; Q_{i,0} represents an original electricity demand during time period i; Δpriᵢ represents a variation of the battery swapping price during time period i; and Δpriⱼ represents a variation of the battery swapping price during time period j.

A constraint formula of the number of the rechargeable batteries is:

$${\sum }_{i = 1}^{T} {\sum }_{n = 1}^{N} {X}_{i , n} \leq C {H}_{i , max} ;$$

Where, CH_{i,max} represents the maximum number of charging piles during time period i.

Constraint formulas of the battery swapping price are:

priₘᵢₙ≤priᵢ≤priₘₐₓ

P_{BSS,min}≤P_{BSS,i}≤P_{BSS,max}

Eₘᵢₙ≤Sᵢ≤Eₘₐₓ;

Where, priₘᵢₙ represents the minimum battery swapping price of the battery swapping station; priₘₐₓ represents the maximum battery swapping price of the battery swapping station; P_{BSS,min} represents the minimum output power of the battery swapping station; P_{BSS,max} represents the maximum output power of the battery swapping station; Eₘᵢₙ represents the minimum number of devices for the battery swapping in the battery swapping station; and Eₘₐₓ represents the maximum number of the devices for the battery swapping in the battery swapping station.

The constraint condition further includes:

$$N - {\sum }_{i = 1}^{T} {\sum }_{n = 1}^{N} {X}_{i , n} \leq {D}_{i + 1} ;$$

Where, Dᵢ₊₁ represents demand of the battery swapping during time period i+1 after the transfer of the battery swapping.

The module 206 is used to perform the optimized dispatching on the electric vehicle battery swapping station according to the optimized charging state of the batteries in the battery swapping station and the optimized demand of the battery swapping.

The system in one embodiment corresponds to the method in another embodiment and thus is described simply, and relevant portions can refer to some descriptions of the method.

Several specific embodiments are used to expound the principle and implementations of the present disclosure. The description of these embodiments is used to assist in understanding the method of the present disclosure and its core conception. In addition, those ordinarily skilled in the art can make various modifications in terms of specific embodiments and scope of application based on the conception of the present disclosure. In conclusion, the content of this specification should not be construed as a limitation to the present disclosure.

1. A dispatching method for an electric vehicle battery swapping station, comprising:
acquiring battery data of electric vehicles and demand of battery swapping of users, wherein the battery data comprises charging power, state of charge (SOC), state of health (SOH), and a rated capacity of batteries;
determining a total charging power and an average charging power of a battery swapping station according to the charging power of the batteries and the demand of the battery swapping of the users;
determining a battery swapping price according to the total charging power and the average charging power of the battery swapping station;
determining an objective function of optimized dispatching of the electric vehicle battery swapping station according to the battery swapping price and the battery data;
optimizing, according to a constraint condition and the objective function, a charging state of batteries in the battery swapping station and the demand of the battery swapping to obtain an optimized charging state of the batteries in the battery swapping station and an optimized demand of the battery swapping; wherein, the constraint condition comprises constraints on the SOH of the batteries, the SOC of the batteries, the demand of the battery swapping, the number of rechargeable batteries, and the battery swapping price; and
performing the optimized dispatching on the electric vehicle battery swapping station according to the optimized charging state of the batteries in the battery swapping station and the optimized demand of the battery swapping.

2. The dispatching method for an electric vehicle battery swapping station according to claim 1, wherein the step of determining the total charging power and the average charging power of a battery swapping station according to the charging power of the batteries and the demand of the battery swapping of the users comprises:
determining the total charging power of the battery swapping station according to the following formula:
$${P}_{BSS , i} = {\sum }_{i = 1}^{T} {P}_{i} \cdot {S}_{i} ;$$
and
determining the average charging power of the battery swapping station according to the following formula:
$${P}_{a v} = \frac{1}{T} {\sum }_{i = 1}^{T} {P}_{i} \cdot {S}_{i} ;$$
wherein, P_{BSS,i} represents the total charging power of the battery swapping station during time period i; Pₐᵥ represents the average charging power of the battery swapping station; Pᵢ represents a charging power of the batteries during time period i; Sᵢ represents the demand of the battery swapping of the users during time period i; and T represents total time.

3. The dispatching method for an electric vehicle battery swapping station according to claim 2, wherein the step of determining a battery swapping price according to the total charging power and average charging power of the battery swapping station comprises:
determining the battery swapping price according to the following formula:
$$p r {i}_{i} = \{ \begin{matrix}⌊ \frac{{P}_{BSS , i} - {P}_{av}}{{step}_{p}} ⌋ \cdot {step}_{pri} + {pri}_{i - 1} & if {P}_{BSS , i} - {P}_{av} \geq {step}_{p} , & {P}_{BSS , i}^{′} > 0 \\ {pri}_{i - 1} - ⌊ \frac{{P}_{BSS , i} - {P}_{av}}{{step}_{p}} ⌋ \cdot {step}_{pri} & if {P}_{BSS , i} - {P}_{av} \geq {step}_{p} , & {P}_{BSS , i}^{′} < 0 \\ {pri}_{i - 1} & else & \end{matrix} ;$$
wherein, priᵢ represents a battery swapping price during time period i; priᵢ₋₁ represents a battery swapping price during time period i−1; stepₚᵣᵢ represents a price step; stepₚ represents a power step; and P′_{BSS,i} represents a slope of the total charging power of the battery swapping station.

4. The dispatching method for an electric vehicle battery swapping station according to claim 3, wherein the step of determining an objective function of optimized dispatching of the electric vehicle battery swapping station according to the battery swapping price and the battery data comprises:
determining the objective function of the optimized dispatching of the electric vehicle battery swapping station according to the following formula:
$$max I = {I}_{R} + {I}_{P} - C = {\sum }_{i = 1}^{T} {\sum }_{m = 1}^{{D}_{i , k}} {\sum }_{k = 1}^{3} p r {i}_{i} \cdot ( 1 - {SOC}_{m} ) \cdot {SOH}_{m} \cdot {Cap}_{m} + {\sum }_{i = 1}^{T} {\sum }_{m = 1}^{{D}_{i , k}} {\sum }_{k = 1}^{3} {M}_{m} \cdot R \cdot ( {SOH}_{0} - S O {H}_{m} ) - {\sum }_{i = 1}^{T} {\sum }_{n = 1}^{N} {X}_{i , n} \cdot {g}_{i} \cdot {P}_{i} \cdot Δ t ;$$
wherein,
$${M}_{m} = \{ \begin{matrix}1 & SOH ∈ ( 0.80 \% ) \\ 0 & All else\end{matrix} \\ {X}_{i , n ,} = \{ \begin{matrix}1 , & Charging \\ 0 , & All else\end{matrix} ;$$
wherein, I represents the objective function; I_{R} represents an income of the battery swapping; I_{P} represents a punishment on the users; C represents a charging cost of the battery swapping station; D_{i,k} represents a demand of the battery swapping during time period i after users of a k^{th} type respond to transfer of the battery swapping; k represents a type of the users, wherein the users are divided into three types according to the SOC of the batteries; m represents a user; SOCₘ represents an SOC of a battery of an m^{th} user; SOH represents an SOH of the battery of the m^{th} user; Capₘ represents a rated capacity of the battery of the m^{th} user; Mₘ represents a punishment state of the users; R represents a unit punishment cost for users whose batteries have an SOH lower than 80%; SOH₀ represents an SOH of the batteries in the battery swapping station; gᵢ represents an electricity price; X_{i,n,} represents a charging state of an n^{th} battery in the battery swapping station during time period i; N represents a total number of the batteries in the battery swapping station; and Δt represents a unit charging time.

5. The dispatching method for an electric vehicle battery swapping station according to claim 4, wherein the step of optimizing, according to a constraint condition and the objective function, a charging state of batteries in the battery swapping station and the demand of the battery swapping comprises:
optimizing, according to the constraint condition and the objective function, the charging state of the batteries in the battery swapping station and the demand of the battery swapping by means of a particle swarm optimization (PSO) algorithm;
wherein,
a constraint formula of the SOH of the batteries is:
0≤SOH≤100%;
a constraint formula of the SOC of the batteries is:
0≤SOC≤100%;
a constraint formula of the demand of the battery swapping is:
D_{i,k}≤D_{i,max};
wherein,
$${D}_{i , k} = ⌈ \frac{{Q}_{i , k}}{C a {p}_{m} ( 1 - {SOC}_{i , k} )} ⌉$$
$${Q}_{i , k} = {Q}_{i , i} + {Q}_{i , j} = {Q}_{i , 0 , k} ( 2 + {ɛ}_{i , i} \frac{p r {i}_{i} - p r {i}_{i , 0}}{p r {i}_{i , 0}} + {ɛ}_{i , i} \frac{p r {i}_{j} - p r {i}_{j , 0}}{p r {i}_{j , 0}} )$$
$${Q}_{i , i} = {Q}_{i , 0 , k} ( 1 + {ɛ}_{i , i} \frac{p r {i}_{i} - p r {i}_{i , 0}}{p r {i}_{i , 0}} )$$
$${Q}_{i , j} = {Q}_{i , 0 , k} ( 1 + {ɛ}_{i , i} \frac{p r {i}_{j} - p r {i}_{j , 0}}{p r {i}_{j , 0}} )$$
$${ɛ}_{i , i} = \frac{Δ {Q}_{i} / {Q}_{i , 0}}{Δ {pri}_{i} / p r {i}_{i , 0}} ;$$
wherein, D_{i,max} represents maximum demand of the battery swapping during time period i; Q_{i,k} represents total electricity demand of the battery swapping of the users of the k^{th} type during time period i; SOC_{i,k} represents an SOC of the batteries of the users of the k^{th} type during time period i; Q_{i,i} represents total electricity demand during time period i, which is generated by a price change during time period i; Q_{i,j} represents total electricity demand during time period i, which is generated by a price change during time period j; Q_{i,0,k} represents electricity demand of the users of the k^{th} type before the price change during time period i; ε_{i,i} represents a self-elasticity coefficient; ε_{i,j} represents a mutual elasticity coefficient; pri_{i,0} represents a battery swapping price before optimization during time period i; priⱼ represents a battery swapping price during time period j; ΔQᵢ represents a variation of electricity demand during time period i; Q_{i,0} represents an original electricity demand during time period i; and Δpriᵢ represents a variation of the battery swapping price during time period i;
wherein, a constraint formula of the number of the rechargeable batteries is:
$${\sum }_{i = 1}^{T} {\sum }_{n = 1}^{N} {X}_{i , n} \leq C {H}_{i , max} ;$$
wherein, CH_{i,max} represents a maximum number of charging piles during time period i;
constraint formulas of the battery swapping price are:
priₘᵢₙ≤priᵢ≤priₘₐₓ
P_{BSS,min}≤P_{BSS,i}≤P_{BSS,max}
Eₘᵢₙ≤Sᵢ≤Eₘₐₓ;
wherein, priₘᵢₙ represents a minimum price of battery swapping of the battery swapping station; priₘₐₓ represents a maximum battery swapping price of the battery swapping station; P_{BSS,min} represents minimum output power of the battery swapping station; P_{BSS,max} represents maximum output power of the battery swapping station; Eₘᵢₙ represents a minimum number of devices for the battery swapping in the battery swapping station; and Eₘₐₓ represents a maximum number of the devices for the battery swapping in the battery swapping station; and
wherein, the constraint condition further comprises:
$$N - {\sum }_{i = 1}^{T} {\sum }_{n = 1}^{N} {X}_{i , n} \leq {D}_{i + 1} ;$$
wherein, Dᵢ₊₁ represents demand of the battery swapping during time period i+1 after the transfer of the battery swapping.

6. A dispatching system for an electric vehicle battery swapping station, comprising:
a data acquisition module used to acquire battery data of electric vehicles and demand of battery swapping of users, wherein the battery data comprises charging power, an SOC, an SOH, and a rated capacity of batteries;
a power calculation module used to determine a total charging power and an average charging power of a battery swapping station according to the charging power of the batteries and the demand of the battery swapping of the users;
a module for calculating a battery swapping price, which is used to determine the battery swapping price according to the total charging power and the average charging power of the battery swapping station;
an objective function determination module used to determine the objective function of optimized dispatching of the electric vehicle battery swapping station according to the battery swapping price and the battery data;
an optimization module used to optimize, according to a constraint condition and the objective function, a charging state of batteries in the battery swapping station and the demand of the battery swapping to obtain an optimized charging state of the batteries in the battery swapping station and an optimized demand of the battery swapping; wherein, the constraint condition comprises constraints on the SOH of the batteries, the SOC of the batteries, the demand of the battery swapping, the number of rechargeable batteries, and the battery swapping price; and
a module used to perform the optimized dispatching on the electric vehicle battery swapping station according to the optimized charging state of the batteries in the battery swapping station and the optimized demand of the battery swapping.

7. The dispatching system for an electric vehicle battery swapping station according to claim 6, wherein the power calculation module is configured to:
determine the total charging power of the battery swapping station according to the following formula:
$${P}_{BSS , i} = {\sum }_{i = 1}^{T} {P}_{i} \cdot {S}_{i} ,$$
and
determine the average charging power of the battery swapping station according to the following formula:
$${P}_{a v} = \frac{1}{T} {\sum }_{i = 1}^{T} {P}_{i} \cdot {S}_{i} ;$$
wherein, P_{BSS,i} represents the total charging power of the battery swapping station during time period i; Pₐᵥ represents the average charging power of the battery swapping station; Pᵢ represents a charging power of the batteries during time period i; Sᵢ represents the demand of the battery swapping of the users during time period i; and T represents total time.

8. The dispatching system for an electric vehicle battery swapping station according to claim 7, wherein the module for calculating the battery swapping price is configured to:
determine the battery swapping price according to the following formula:
$$pr {i}_{i} = \{ \begin{matrix}⌊ \frac{{P}_{BSS , i} - {P}_{av}}{{step}_{p}} ⌋ \cdot {step}_{pri} + {pri}_{i - 1} & if {P}_{BSS , i} - {P}_{av} \geq {step}_{p} , & {P}_{BSS , i}^{′} > 0 \\ {pri}_{i - 1} - ⌊ \frac{{P}_{BSS , i} - {P}_{av}}{{step}_{p}} ⌋ \cdot {step}_{pri} & if {P}_{BSS , i} - {P}_{av} \geq {step}_{p} , & {P}_{BSS , i}^{′} < 0 \\ {pri}_{i - 1} & else & \end{matrix} ;$$
wherein, priᵢ represents a battery swapping price during time period i; priᵢ₋₁ represents a battery swapping price during time period i−1; stepₚᵣᵢ represents a price step; stepₚ represents a power step; and P′_{BSS,i} represents slope of the total charging power of the battery swapping station.

9. The dispatching system for an electric vehicle battery swapping station according to claim 8, wherein the objective function determination module comprises:
an objective function determination unit used to determine the objective function of the optimized dispatching of the electric vehicle battery swapping station according to the following formula:
$$max I = {I}_{R} + {I}_{P} - C = {\sum }_{i = 1}^{T} {\sum }_{m = 1}^{{D}_{i , k}} {\sum }_{k = 1}^{3} p r {i}_{i} \cdot ( 1 - {SOC}_{m} ) \cdot {SOH}_{m} \cdot {Cap}_{m} + {\sum }_{i = 1}^{T} {\sum }_{m = 1}^{{D}_{i , k}} {\sum }_{k = 1}^{3} {M}_{m} \cdot R \cdot ( {SOH}_{0} - S O {H}_{m} ) - {\sum }_{i = 1}^{T} {\sum }_{n = 1}^{N} {X}_{i , n} \cdot {g}_{i} \cdot {P}_{i} \cdot Δ t ;$$
wherein,
$${M}_{m} = \{ \begin{matrix}1 & SOH ∈ ( 0.80 \% ) \\ 0 & All else\end{matrix} \\ {X}_{i , n ,} = \{ \begin{matrix}1 , & Charging \\ 0 , & All else\end{matrix} ;$$
wherein, I represents the objective function; I_{R} represents an income of the battery swapping; I_{P} represents a punishment on the users; C represents a charging cost of the battery swapping station; D_{i,k} represents demand of the battery swapping during time period i after users of a k^{th} type respond to transfer of the battery swapping; k represents a type of the users, wherein the users are divided into three types according to the SOC of the batteries; m represents a user; SOCₘ represents an SOC of a battery of an m^{th}user; SOHₘ represents an SOH of the battery of the m^{th} user; Capₘ represents a rated capacity of the battery of the m^{th} user; Mₘ represents a punishment state of the users; R represents a unit punishment cost for users whose batteries have an SOH lower than 80%; SOH₀ represents an SOH of the batteries in the battery swapping station; gᵢ represents an electricity price; X_{i,n,} represents a charging state of an n^{th} battery in the battery swapping station during time period i; N represents a total number of the batteries in the battery swapping station; and Δt represents a unit charging time.

10. The dispatching system for an electric vehicle battery swapping station according to claim 9, wherein the optimization module comprises:
an optimization unit used to optimize, according to the constraint condition and the objective function, the charging state of the batteries in the battery swapping station and the demand of the battery swapping by means of a PSO algorithm;
wherein,
a constraint formula of the SOH of the batteries is:
0≤SOH≤100%;
a constraint formula of the SOC of the batteries is:
0≤SOC≤100%;
a constraint formula of the demand of the battery swapping is:
D_{i,k}≤D_{i,max};
wherein,
$${D}_{i , k} = ⌈ \frac{{Q}_{i , k}}{C a {p}_{m} ( 1 - S O {C}_{i , k} )} ⌉$$
$${Q}_{i , k} = {Q}_{i , i} + {Q}_{i , j} = {Q}_{i , 0 , k} ( 2 + {ɛ}_{i , i} \frac{p r {i}_{i} - p r {i}_{i , 0}}{p r {i}_{i , 0}} + {ɛ}_{i , i} \frac{p r {i}_{j} - p r {i}_{j , 0}}{p r {i}_{j , 0}} )$$
$${Q}_{i , i} = {Q}_{i , 0 , k} ( 1 + {ɛ}_{i , i} \frac{p r {i}_{i} - p r {i}_{i , 0}}{p r {i}_{i , 0}} )$$
$${Q}_{i , j} = {Q}_{i , 0 , k} ( 1 + {ɛ}_{i , i} \frac{p r {i}_{j} - p r {i}_{j , 0}}{p r {i}_{j , 0}} )$$
$${ɛ}_{i , i} = \frac{Δ {Q}_{i} / {Q}_{i , 0}}{Δ {pri}_{i} / p r {i}_{i , 0}} ;$$
wherein, D_{i,max} represents maximum demand of the battery swapping during time period i; Q_{i,k} represents total electricity demand of the battery swapping of the users of the k^{th} type during time period i; SOC_{i,k} represents an SOC of the batteries of the users of the k^{th} type during time period i; Q_{i,i} represents total electricity demand during time period i, which is generated by a price change during time period i; Q_{i,j} represents total electricity demand during time period i, which is generated by a price change during time period j; Q_{i,0,k} represents electricity demand of the users of the k^{th} type before the price change during time period i; ε_{i,i} represents a self-elasticity coefficient; ε_{i,j} represents a mutual elasticity coefficient; pri_{i,0} represents a battery swapping price before optimization during time period i; priⱼ represents a battery swapping price during time period j; ΔQᵢ represents a variation of electricity demand during time period i; Q_{i,0} represents an original electricity demand during time period i; and Δpriᵢ represents a variation of the battery swapping price during time period i;
wherein, a constraint formula of the number of the rechargeable batteries is:
$${\sum }_{i = 1}^{T} {\sum }_{n = 1}^{N} {X}_{i , n} \leq {CH}_{i , max} ;$$
wherein, CH_{i,max} represents a maximum number of charging piles during time period i;
constraint formulas of the battery swapping price are:
priₘᵢₙ≤priᵢ≤priₘₐₓ
P_{BSS,min}≤P_{BSS,i}≤P_{BSS,max}
Eₘᵢₙ≤Sᵢ≤Eₘₐₓ
wherein, priₘᵢₙ represents a minimum battery swapping price of the battery swapping station; priₘₐₓ represents a maximum battery swapping price of the battery swapping station; P_{BSS,min} represents minimum output power of the battery swapping station; P_{BSS,max} represents maximum output power of the battery swapping station; Eₘᵢₙ represents a minimum number of devices for the battery swapping in the battery swapping station; and Eₘₐₓ represents a maximum number of the devices for the battery swapping in the battery swapping station; and
wherein, the constraint condition further comprises:
$$N - {\sum }_{i = 1}^{T} {\sum }_{n = 1}^{N} {X}_{i , n} \leq {D}_{i + 1} ;$$
wherein, Dᵢ₊₁ represents demand of the battery swapping during time period i+1 after the transfer of the battery swapping.
